(19) United States
(12) Patent Application Publication
(10) Pub. No.: US 2008/0084164 A1
(43) Pub. Date: Apr. 10, 2008

(54) Dielectric Barrier discharge lamp, backlight device, and liquid crystal display device

(76) Inventors: Masaki Hirohashi, Tokyo (JP); Shinichiro Hataoka, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/979,028

(22) Filed: Oct. 30, 2007

Related U.S. Application Data
(63) Continuation of application No. PCT/JP2007/058509, filed on Apr. 19, 2007.

(30) Foreign Application Priority Data
Jun. 9, 2006 (JP) 2006-160643

(51) Int. Cl. H01J 61/06; F21V 7/05

(52) U.S. Cl. 313/607; 362/615

(57) ABSTRACT

A dielectric barrier discharge lamp has a pair of external electrodes disposed in series along the direction of tube axis outside a bulb. A lamp capacity, which is an electrostatic capacity between the pair of external electrodes, is set such that a discharge charge quantity per unit length of the external electrodes and one discharge between the pair of external electrodes is less than 100 nC/m. The lamp capacity is regulated, for example, by a width or a length of the external electrodes or a clearance distance to the external electrodes and bulb. A high lamp efficiency can be accomplished.

This is a continuous application of International Application No. PCT/JP2007/58509, filed Apr. 19, 2007.

### BACKGROUND OF THE INVENTION

The present invention relates to a dielectric barrier discharge lamp and more particularly to improvement of lamp efficiency of the dielectric barrier discharge lamp.

Recently, in addition to lamps using mercury as a discharge medium (referred to hereinbelow as mercury-containing lamps), lamps using no mercury (referred to hereinbelow as mercury-free lamps) have been widely studied as lamps for use, e.g., in backlight devices for liquid crystal displays. The mercury-free lamps are preferable for reasons in view of environmental standpoint as well as small fluctuation of light emission intensity under an effect of changes in temperature with time. A dielectric discharge lamp mainly used as the mercury free lamps is “dielectric barrier type” in which discharge is occurred via a tubular wall of a light emitting tube enclosing a rare gas have been mainly used as mercury-free lamps.

On the other hand, because of that a higher brightness is required for liquid crystal display devices, a higher brightness is strongly required for backlight devices used in liquid crystal display devices. For example, Japanese Patent Application Laid-open Publication No. H5-82101 discloses a technology aimed at discharge stabilization and brightness increase (increase in level of illumination) in a dielectric barrier discharge lamp (Paragraphs [0029], [0030], and [0036], FIG. 7).

FIGS. 8A and 8B show a rare gas discharge lamp 1 disclosed in Japanese Patent Application Laid-open Publication No. H5-82101. The rare gas discharge lamp 1 has a pair of external electrodes 3 closely attached to an outer surface of a glass bulb 2 and disposed close to each other within a limit of that no dielectric breakdown occurs. A fluorescent layer 4 is formed on an inner circumferential surface of the glass bulb 2. A drive voltage is applied by a lighting circuit 5 to the external electrodes 3.

Japanese Patent Application Laid-open Publication No. H5-82101 teaches that the discharge state of the rare gas discharge lamp 1 is assumed to be stabilized by disposing a pair of external electrodes 3 close to each other as long as that no insulation breakdown occurs between them. Further, Japanese Patent Application Laid-open Publication No. H5-82101 teaches that that a larger surface area of external electrodes 3 increases inputted electric power to increase output light flux from the rare gas discharge lamp 1, resulting in that a high lamp efficiency can be maintained.

### SUMMARY OF THE INVENTION

However, by dedicated studies on the efficiency of dielectric barrier discharge lamps by the present inventors, it was found out that the arrangement assumed to increase efficiency according to Japanese Patent Application Laid-open No. H5-82101 actually does not necessarily contribute to the increase in lamp efficiency. Specifically, as a result of researches including various experiments using lamp efficiency (lm/W) obtained by dividing an output light flux of the lamp by the power inputted to the lamp as an indicator of efficiency of dielectric barrier discharge lamps, it was found out that the setting a large surface area of external electrodes 3, as taught in Japanese Patent Application Laid-open Publication No. H5-82101, is actually not important in terms of improving lamp efficiency. Further, it was found out that specific feature contradictory to teaches by Japanese Patent Application Laid-open Publication No. H5-82101 can effectively increase lamp efficiency.

The present invention is based on the new knowledge, and it is an object of the present invention to provide a dielectric barrier discharge lamp with greatly increased lamp efficiency as well as a backlight device and liquid crystal device using the same.

The present inventors have found that when a discharge charge quantity per unit length of external electrodes between external electrodes and per one discharge is less than a certain value in a dielectric barrier discharge lamp of the so-called external-external electrode system, a lamp efficiency obtained by dividing an output light flux of the lamp by the power inputted to the lamp is greatly increased.

Specifically, a first aspect of the present invention provides a dielectric barrier discharge lamp comprising, a bulb, a discharge medium comprising a rare gas and filled in the bulb, at least a pair of external electrodes disposed outside the bulb and in series along a tube axis direction of the bulb, and a lighting circuit for applying an alternating voltage to the pair of external electrodes so as to repeatedly generate dielectric barrier discharges and convert the rare gas into plasma for light emission. A lamp capacity defined as an electrostatic capacity between the pair of external electrodes is set such that a discharge charge quantity between the pair of external electrodes per unit length of the external electrode and per one discharge (referred to as merely discharge charge quantity per length hereinafter) is less than 100 nC/m.

The discharge charge quantity per unit length is proportional to a product of lamp efficiency and voltage applied between the external electrodes (lamp voltage). However, because lamp voltage has to ensure stable discharge initiation and reliable lighting, the range in which the lamp voltage can be adjusted is narrow. Therefore, the discharge charge quantity per unit length has to be set within a range below 100 nC/m by adjusting the lamp capacity.

The lamp capacity is proportional to a relative permittivity of a tubular wall of the bulb and a surface area of external electrodes (lengths and widths of external electrodes), and inversely proportional to a clearance distance between the external electrodes and bulb. Of these parameters, because changing the relative permittivity requires changing material of the bulb, the relative permittivity cannot be easily adjusted to desired value. Therefore, lamp capacity is preferably set by regulating at least one parameter from among the lengths of the external electrodes, widths of the external electrodes, and clearance distance between the external electrodes and bulb.

As long as lamp capacity is set such that the discharge charge quantity per unit length is less than 100 nC/m, the external electrodes may be set either to be in contact with the bulb or to be separated at a distance from an outer circumferential surface of the bulb.

A second aspect of the present invention provides a backlight device comprising the above-mentioned dielectric barrier discharge lamp and a diffuser plate with a light incoming surface and light outgoing surface for transmitting from the light incoming surface to the light outgoing surface a light emitted from the dielectric barrier discharge lamp so that the light is emitted from the light outgoing surface.

A third aspect of the present invention provides a liquid crystal display device comprising the above-mentioned backlight device and a liquid crystal display panel disposed opposite to the light outgoing surface of the diffuser plate.

The present invention can be applied not only to backlight devices for liquid crystal display devices, but also to backlight sources for signboards, indoor illumination sources, and illumination light sources for vehicles.

In the dielectric barrier discharge lamp of an external-external electrode system, because the lamp capacity, i.e., the electrostatic capacity between the pair of external electrodes, is set such that the discharge charge quantity between the pair of external electrodes per unit length of the external electrodes and per one discharge is less than 100 nC/m, lamp efficiency (lm/W) can be greatly increased.

### BRIEF DESCRIPTION OF THE DRAWINGS

Other objects and characteristics of the present invention shall be clarified by the following description on the preferred embodiments with reference to the accompanying drawings.

FIG. 1A is a schematic cross-sectional view along a tube axis direction of a dielectric barrier discharge lamp 100A (of external electrode contact type) according to an embodiment of the present invention;

FIG. 1B is a cross-sectional view along a line I-I line in FIG. 1A;

FIG. 2A is a schematic cross-sectional view along the tube axis direction of a dielectric barrier discharge lamp 100B (of external electrode non-contact type) in the embodiment of the present invention;

FIG. 2B is a cross-sectional view along a line II-II in FIG. 2A;

FIG. 3 is an equivalent circuit of the dielectric barrier discharge lamp 100 according to the embodiment of the present invention;

FIG. 4 is a schematic cross-sectional view of the configuration for measuring a discharge charge quantity;

FIG. 5 is an equivalent circuit of the configuration shown in FIG. 4;

FIG. 6 is a V-Q Lissajous waveform figure;

FIG. 7 is a graph showing the relationship between the discharge charge quantity q0 per unit length and lamp efficiency η;

FIG. 8A is a cross-sectional view in the tube axis direction of a conventional rare gas fluorescent lamp 1;

FIG. 8B is a cross-sectional view along a line VIII-VIII in FIGS. 8A, 8B.

### DESCRIPTION OF THE PREFERRED EMBODIMENTS

Embodiments of the present invention will be described below in detail with reference to the appended drawings.

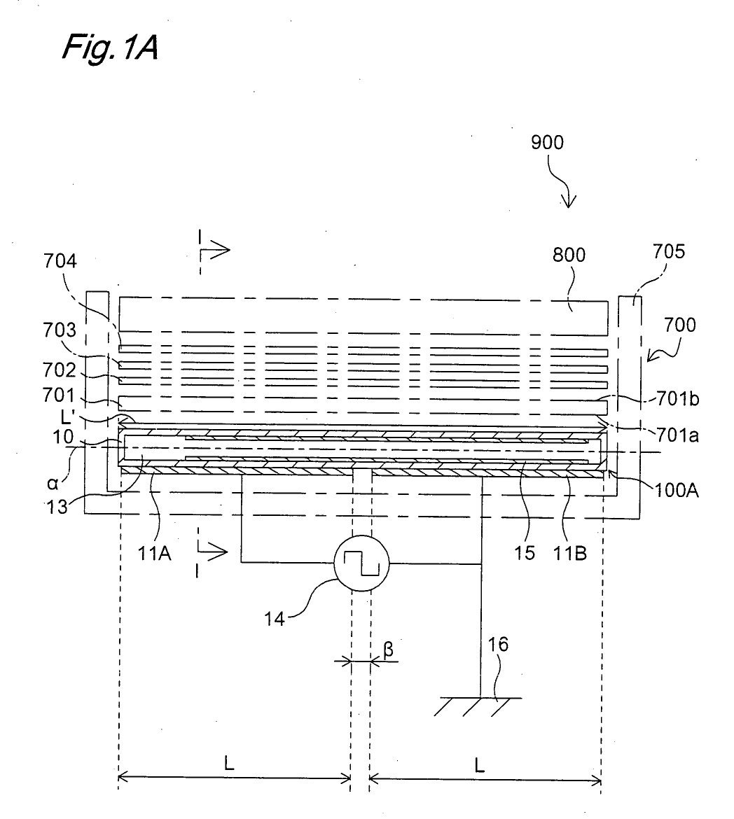

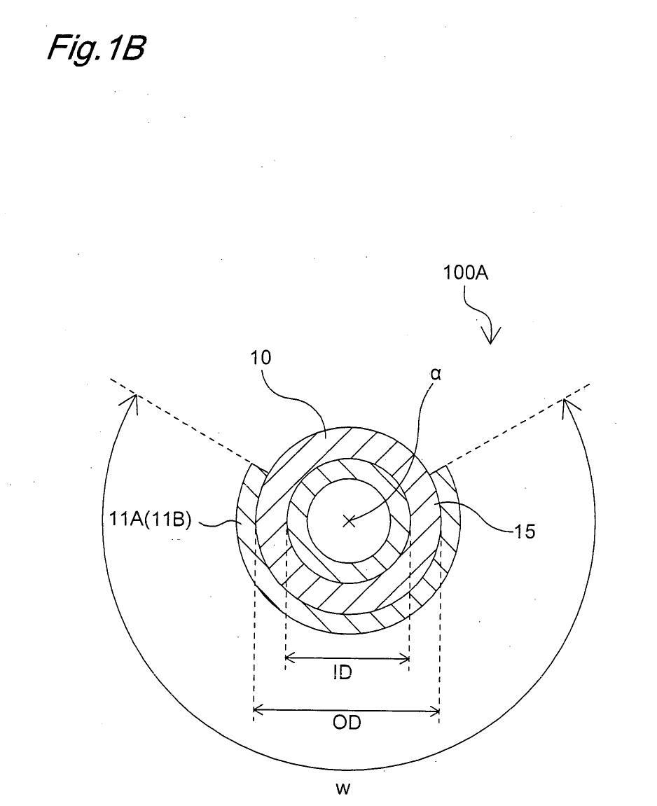

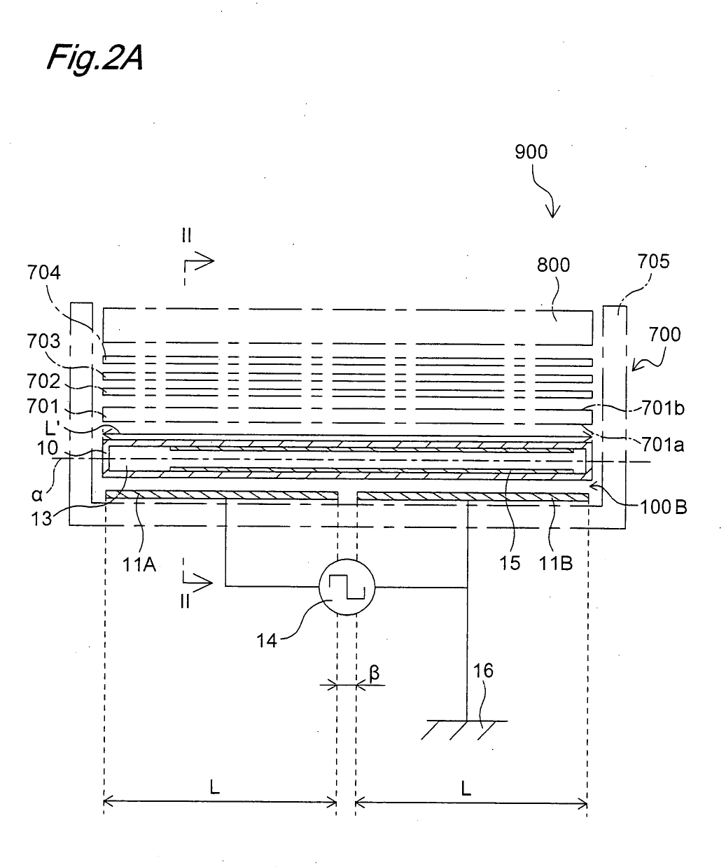

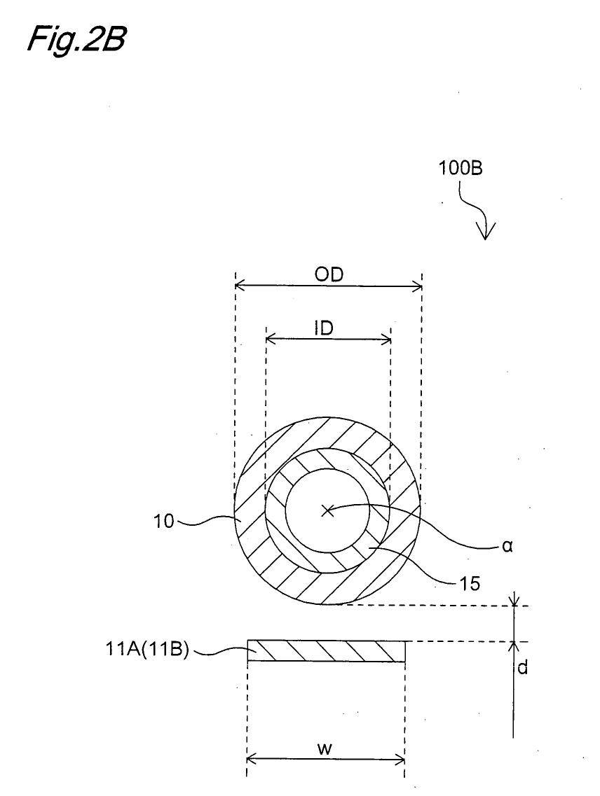

FIGS. 1A, 1B and FIGS. 2A, 2B respectively show dielectric barrier discharge lamps 100A, 100B of embodiments of the present invention. As will be described later in greater detail, the present invention greatly increases lamp efficiency in the dielectric barrier discharge lamp of an external-external electrode type by adequately setting the lamp capacity, which is an electrostatic capacity between a pair of the external electrodes. As long as the lamp capacity is set within the appropriate range, the lamp may have a basic structure in which external electrodes 11A, 11B are closely contact with a bulb 10 (an external electrode contact type) as in the dielectric barrier discharge lamp 100A shown in FIGS. 1A, 1B, or a basic structure in which external electrodes 11A, 11B are disposed at a distance from an outer circumferential surface of the bulb 10 (an external electrode non-contact type), as in the dielectric barrier discharge lamp 100B shown in FIGS. 2A, 2B. The dielectric barrier discharge lamps 100A, 100B will be together referred to as dielectric barrier discharge lamp 100, if necessary.

A structure and configuration of the dielectric barrier discharge lamp 100A shown in FIGS. 1A, 1B will be described below by way of an example.

Referring to FIGS. 1A, 1B, a pair of external electrodes 11A, 11B (when it is not necessary to distinguish the external electrodes 11A, 11B from one another, they will be together referred to as external electrodes 11) are disposed on an outside of the bulb or light emitting tube 10 of the dielectric barrier discharge lamp 100A so as to be disposed adjacently to each other in series along a direction of a tube axis “α” of the bulb 10. Further, both of the external electrodes 11A, 11B are formed in close contact with the outer circumferential surface of the light emitting tube 10 and have a circular arc shape in a cross section perpendicular to the tube axis “α”. A lighting circuit 14 is electrically connected to the pair of external electrodes 11. The lighting circuit 14 applies a rectangular AC voltage to the external electrodes 11. One output terminal of the lighting circuit 14 is connected to the ground 16.

The light emitting tube 10 is typically in the form of a small-diameter tube that has a high strength and can be easily manufactured under mass production conditions. Further, material of the light emitting tube 10 is typically a borosilicate glass, but other types of glass such as quartz glass, soda glass, and lead glass may also be used. An outer diameter OD of the light emitting tube 10 is usually approximately 1.0 mm to 10 mm, but this range is not limiting. For example, the outer diameter may be approximately 30 mm; such a diameter has been used in fluorescent illumination lamps for general illumination. The light emitting tube 10 is not limited to a straight linear shape and may have a U-like or rectangular shape. In the present embodiment, a straight tube with an inner diameter ID of 2.0 mm and a outer diameter OD of 3.0 mm is used as the light emitting tube 10.

The light emitting tube 10 is sealed, and a discharge medium (not shown in the figure) is filled inside thereof, that is, in a discharge space 13. The discharge medium comprises at least one gas consisting mainly of a rare gas. The pressure of the filled gas, that is, the pressure inside the discharge tube 10 is approximately 0.1 kPa to 76.0 kPa. In the present embodiment, a mixed gas comprising 60% xenon and 40% argon is filled at 20 kPa in the light emitting tube 10. However, other gas conditions can be employed.

The external electrodes 11 can be formed from a transparent conductive structure comprising a metal such as copper, aluminum, or stainless steel, or tin oxide, indium oxide, or the like as the main component. Further, by using the external electrodes 11 that were subjected to a mirror-surface reflection processing, it is possible to cause efficient reflection of light from the light emitting tube 10 to the external electrodes 11 and realize a high light take-out efficiency, without disposing a high-reflectance sheet between the external electrode 11 and the light emitting tube 10. The external electrodes 11A and 11B are disposed close to each other within a range in which no insulation breakdown occurs during voltage application. Specifically, a distance “β” between the external electrodes 11A, 11B in the direction of the tube axis “α” is preferably within a range between 0.1 mm and 50 mm. This is because where the distance is less than 0.1 mm, insulation breakdown occurs, and where the distance is more than 50 mm, the discharge becomes unstable when a light emitting tube 10 of a typical size is used or when a general drive voltage for a backlight device is applied. In the present embodiment, the distance “β” is 7 mm.

The external electrodes 11A, 11B have the same length “L” in the direction of the tube axis “a”. However, it is not necessary that the two electrodes have the same length.

A fluorescent layer 15 is formed to convert the wavelength of light emitted from the discharge medium. Light of various wavelength can be obtained by changing the material of the fluorescent layer 15. For example, white light or red, green, and blue light can be obtained. The fluorescent layer 15 can be formed from materials that are used in so-called fluorescent lamps for general illumination, plasma displays, and the like.

The lighting circuit 14 supplies a rectangular wave AC voltage to the external electrodes 11. For the dielectric barrier discharge, applying a rectangular wave voltage is generally preferred because it raises lamp efficiency (a value obtained by dividing output light flux from the light emitting tube 10 by electric power inputted to the light emitting tube 10). The applied voltage waveform is not limited to the rectangular wave and also may be a sine wave, as long as that the light emitting tube 10 can be lighted. By applying the AC voltage from the lighting circuit 14, the dielectric barrier discharge is repeatedly initiated via the tubular wall of the light emitting tube 10, an therefore the rare gas contained in the discharge medium is converted into plasma, resulting in that light is emitted.

In the dielectric barrier discharge lamp 100B shown in FIGS. 2A, 2B, each of the external electrodes 11A, 11B is disposed at a distance from the outer circumferential surface of the light emitting tube 10, and a shortest clearance distance “t” to the outer circumferential surface of the light emitting tube 10 in the entire portion in the direction of the tube axis “a” is constant. Further, in the dielectric barrier discharge lamp 100B, the external electrodes 11A, 11B are in the form of a flat plate or a band and have a rectangular shape in a cross section perpendicular to the tube axis “α”. Other features of the dielectric barrier discharge lamp 100B shown in FIGS. 2A, 2B are identical to those of the lamp shown in FIGS. 1A, 1B.

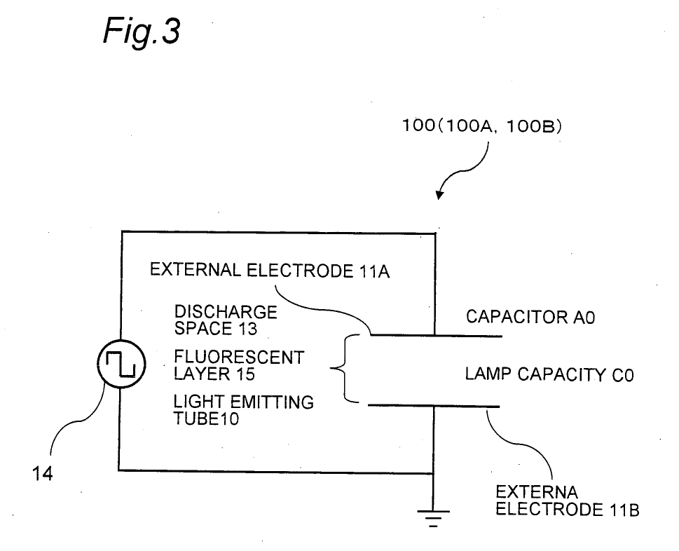

Then, the lamp capacity will be explained below. FIG. 3 shows an equivalent circuit of the dielectric barrier discharge lamp 100. The dielectric barrier discharge lamp 100 is equivalent to a capacitor “A0” having a lamp capacity “C0”. A dielectric of the capacitor “A0” is constituted by the discharge space 13 inside the light emitting tube 10, the fluorescent layer 15, and the light emitting tube 10 sandwiched between the external electrodes 11A, 11B. The inventors have experimentally found the settings that greatly increase the lamp efficiency of the dielectric barrier discharge lamp 100 with respect to this lamp capacity “C0”. These settings will be explained below in greater detail.

First, a method for measuring the discharge charge quantity “q0” and lamp efficiency “η” of the dielectric barrier discharge lamp 100 will be explained.

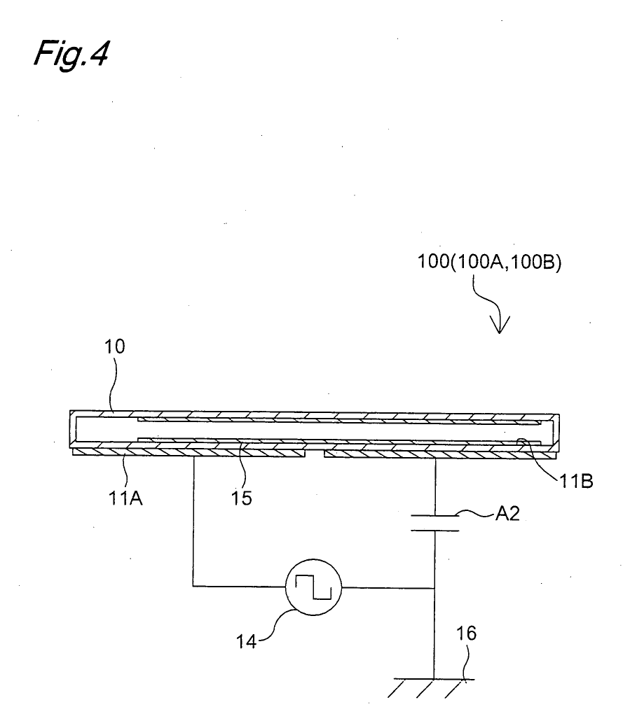

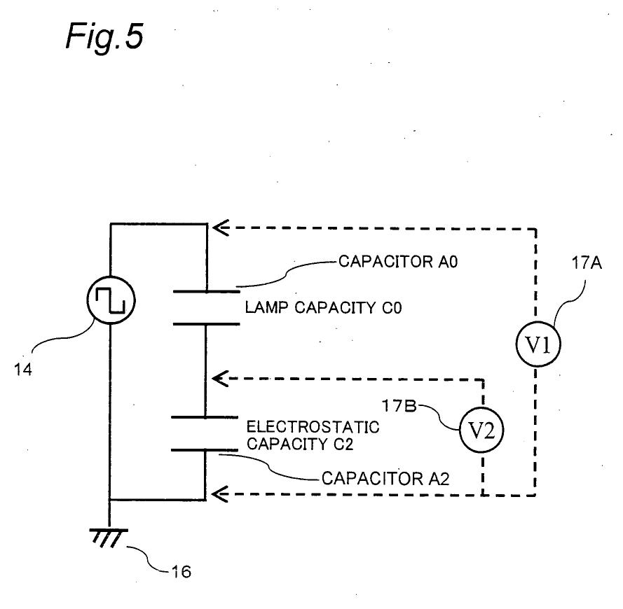

As shown in FIG. 4, in order to measure the discharge charge quantity “q0” and lamp efficiency “η” of the dielectric barrier discharge lamp 100, a measurement capacitor “A2” having an electrostatic capacity “C2” is connected between the external electrode 11B and ground 16 so as to be in serial with the lamp capacity “C0”. FIG. 5 is an equivalent circuit of the configuration shown in FIG. 4. In this equivalent circuit, voltage probes 17A, 17B are respectively connected to a position where a sum total voltage “V1” applied to the lamp capacity “C0” and electrostatic capacity “C2” can be measured and a position where a voltage “V2” applied to the electrostatic capacity “C2” can be measured. In order to decrease effect on voltage applied to the lamp, the electrostatic capacity “C2” of the capacitor “A2” has to be set sufficiently lower than that of the lamp capacity “C0”. In the present embodiment, a capacitor with an electrostatic capacity of approximately several tens of nanofarads is used as the measurement capacitor “A2” is used, whereas the lamp capacity “C0” is several tens of picofarads.

In this circuit configuration, voltages “V1”, “V2” are measured with the voltage probes 17A, 17B under a condition where the light emitting tube 10 is lighted by applying a rectangular waveform voltage from the lighting circuit 14. The voltage applied between the external electrodes 11A, 11B, that is, the lamp voltage “V0”, is calculated by subtracting the measured voltage “V2” from the measured voltage “V1”, as shown by a formula (1) below.
V0=V1−V2 (1)

The capacitor “A2” and the capacitor “A0” constituted by the dielectric barrier discharge lamp 100 are connected in serial. Therefore, the electric charge “Q” accumulated in the capacitor “A0” constituted by the dielectric barrier discharge lamp 100 is calculated as a product of the electrostatic capacity “C2” of the capacitor “A2” and the voltage “V2”, as shown by a formula (2) below.
Q=C2×V2 (2)

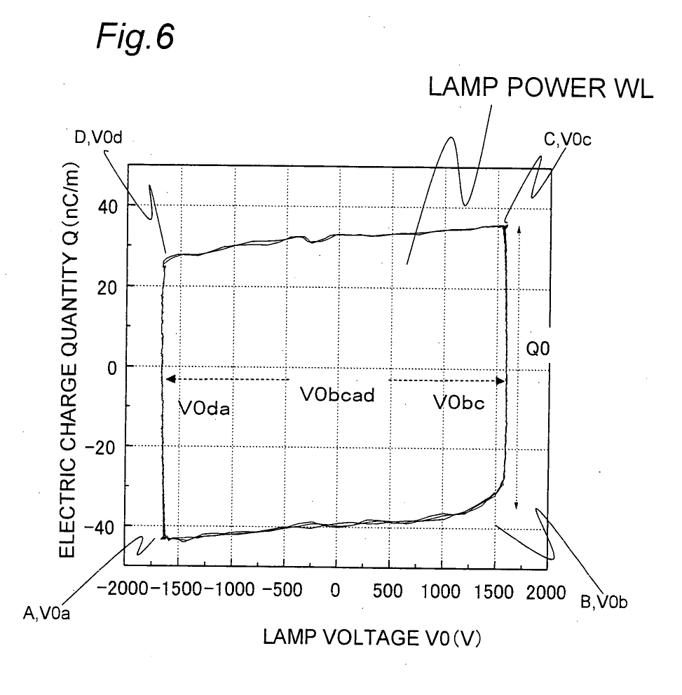

FIG. 6 shows a V-Q Lissajous figure in which the lamp voltages “V0” and the electric charges “Q” accumulated in the capacitor “A0” calculated by the above-described method are respectively plotted against the abscissa and ordinate. Here, a lamp power “WL” is a product of lamp current “I” and lamp voltage “V0”, that is, a product of the amount of electric charge flowing per unit time and lamp voltage “V0”, and therefore equivalent to a value obtained by multiplying a drive frequency “f” of the lighting circuit 14 by the area “S” bounded by points “A”, “B”, “C”, and “D” of the V-Q Lissajous figure as shown in a formula (2).
WL=S×f (3)

Here, plots from the point “A” to the point “B” and from the point “C” to point “D” represent changes in the voltage “V0” and accumulation of the electric charge “Q” to capacitor “A0” in the no-discharge interval. On the other hand, plots from the point “B” to the point “C” and from the point “D” to the point “A” represent changes in the voltage “V0” and accumulation of the electric charge “Q” to the capacitor “A0” from the start to the end of electric discharge in the discharge space 13. In other words, changes in the electric charge “Q” from the point “B” to the point “C” and from point “D” to the point “A” are electric charges moving inside the discharge space 13 due to discharge. The quantity of the accumulated electric charge “Q” within the intervals from the point “B” to the point “C” and from the point “D” to the point “A” is defined as a discharge charge quantity “Q0” per one discharge.

The lamp voltage “V0” at the points “B”, “C” will be respectively denoted by “V0b”, “V0c”, and an average voltage value thereof will be denoted by “V0bc”. Similarly, the lamp voltage “V0” at the points “D” and “A” will be respectively denoted by “V0d”, “V0a”, and an average voltage value thereof will be denoted by “V0da”. Because variations of the lamp voltage “V0” from the point “B” to the point “C” and from the point “D” to the point “A” is subtle, the discharge charge quantity “Q0” is approximately equivalent to a value obtained by dividing the surface area “S” by “V0bcda”, which is a value obtained by subtracting the average voltage value “V0da” from the average voltage value “V0bc”, as represented by a following formula (4).
Q0=S/V0bcda (4)

In the dielectric barrier discharge lamp 100 of the present embodiment, since the external electrodes 11A, 11B extend in the direction of the tube axis “a” of the light emitting tube 10, the discharge charge quantity “Q0” of the lamp 100 differs depending on the lengths “L” of the external electrodes 11A, 11B. Accordingly, in order to evaluate the discharge charge quantity with eliminating the effect of the length “L” of external electrodes 11A, 11B, the value obtained by dividing the discharge charge quantity “Q0” by the length “L” of external electrodes 11A, 11B is defined as a discharge charge quantity “q0” per one discharge and per unit length of external electrodes 11A, 11B as shown in following formula (5).
q0=Q0/L (5)

Where a total light flux value outputted from the dielectric barrier discharge lamp 100 is denoted by “φ”, the lamp efficiency “η” can be calculated by following formula (6) by using the lamp power “WL” obtained from the formula (3).
η=φ/WL (6)

As described above, the V-Q Lissajous figure of the dielectric barrier discharge lamp 100 can be obtained using the dummy capacitor “A2” (FIG. 4), and lamp efficiency “η” and discharge charge quantity “q0” per unit length can be calculated by using the Lissajous figure.

The correlation between the discharge charge quantity “q0” per unit length and the lamp efficiency “η” had been studied by the inventors. First, a method for changing the discharge charge quantity “q0” will be explained.

As described hereinabove, the dielectric barrier discharge lamp 100 is equivalent to the capacitor “A0” having the lamp capacity “C0” in which served as the dielectric are the discharge space 13 inside the light emitting tube 10 the fluorescent layer 15, and the light emitting tube 10 sandwiched between the external electrodes 11A and 11B. As described hereinabove, the discharge charge quantity “Q0” is a charge accumulated in the capacitor “A0” when the dielectric barrier discharge lamp 100 is discharged. Generally, electric charge is a product of electrostatic capacity and voltage. Therefore, a simple method to reduce the discharge charge quantity “Q0” can involve decreasing the lamp capacity “C0” or reducing the lamp voltage “V0”. However, the lamp voltage “V0” has to be set to a voltage that can reliably light the lamp. In the present embodiment, because the lamp voltage “V0” is set within a range from a minimum voltage necessary for a stable discharge of the dielectric barrier discharge lamp 100 to a voltage higher than this minimum voltage by 20%, further decrease in the lamp voltage is impossible. Thus, because the lamp voltage has to ensure the initiation of a stable discharge at which lighting can be maintained, a range in which the lamp voltage can be adjusted is narrow. Accordingly, in the present embodiment, the discharge charge quantity “Q0” (discharge charge quantity “q0” per unit length) is adjusted by changing the lamp capacity “C0”.

The lamp capacity “C0” is proportional to the relative permittivity of the tubular wall of light emitting tube 10 and the surface area of external electrodes 11, whereas it is inversely proportional to the clearance distance “d” between the external electrodes 11 and light emitting tube 10. Therefore, considerable options for varying the lamp capacity “C0” includes, changing the surface area of external electrodes 11A, 11B, more specifically, changing the width “w”, which is the length in the direction perpendicular to the tube axis “α” and/or the length “L” in the direction of the tube axis “α” of the external electrodes 11A, 11B, changing the clearance distance “d” between the external electrodes 11A, 11B and light emitting tube 10, and changing the material constituting the light emitting tube 10 to very the relative permittivity “ε”. However, in order to change the relative permittivity “ε”, it is necessary to change the material, and the adjustment to the desired value is not easy. Accordingly, in the present embodiment, a method of changing the lamp capacity “C0” by adjusting the clearance distance “d” between the light emitting tube 10 and external electrodes 11 and the width “w” and length “L” of the external electrodes 11A, 11B is used as the simplest method for changing the lamp capacity C0.

A plurality types of the dielectric barrier discharge lamps 100 (22 types) with different lamp capacities “C0” (clearance distances “d” between the light emitting tube 10 and external electrodes 11 and the widths “w” and lengths “L” of the external electrodes 11A, 11B) were fabricated. For these dielectric barrier discharge lamps 100, discharge charge quantities “q0” and lamp efficiencies “η” were measured by the above-described methods, and relationship the discharge charge quantities “q0” and lamp efficiencies “η” was examined.

The total light flux φ of each of the dielectric barrier discharge lamps 100 was measured by disposing the dielectric barrier discharge lamp 100 inside an integrating sphere and lighting the lamps with a high-voltage pulse power source (SBP-5K-HF-1, HAIDENLABORATORY Japan) serving as a lighting circuit 14. The high-voltage pulse power source had a positive-negative alternative rectangular drive waveform, and the peak-peak value of voltage changed from 2 kV to 8 kV, depending on the lamp capacity “C0” and length L′ of the light emitting tube 10 under the condition where the voltage applied was sufficient to make the dielectric barrier discharge lamps 100 discharge with good stability.

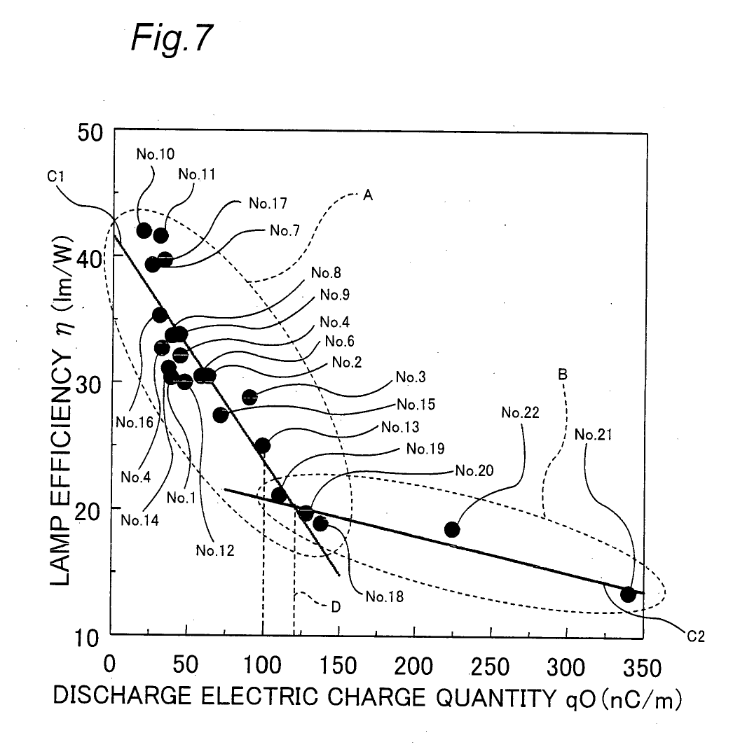

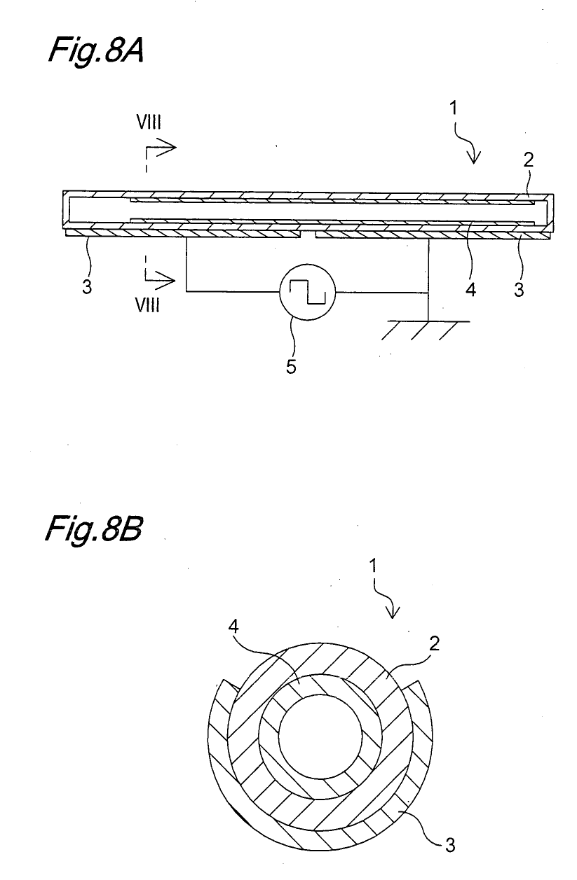

The measurement results on clearance distance “d”, width “w” of external electrodes 11A, 11B, length “L” of external electrodes 11A, 11B, discharge charge quantity “q0” per unit length, and lamp efficiency “η” of each dielectric barrier discharge lamp 100 supplied for measurements are shown in Table 1 below. FIG. 7 shows a graph in which the discharge charge quantities “q0” per unit length are plotted against the abscissa and the lamp efficiencies “η” are plotted against the ordinate based on the results listed in Table 1.

TABLE 1

| | External electrodes | | | Characteristics | |
|---|---|---|---|---|---|
| | | | Clearance | Discharge | |
| | | | distance | charge | Lamp |
| | Length L | Width W | d | quantity q0 | efficiency η |
| No. | (mm) | (mm) | (mm) | (nC/m) | (lm/W) |
| 1 | 300 | 3 | 3 | 38.9 | 30.4 |
| 2 | 300 | 3 | 1 | 63.2 | 30.5 |
| 3 | 300 | 3 | 0.5 | 90.4 | 28.8 |
| 4 | 225 | 3 | 3 | 32.6 | 32.7 |
| 5 | 225 | 3 | 1 | 44.8 | 32.1 |
| 6 | 225 | 3 | 0.5 | 58.5 | 30.5 |
| 7 | 150 | 3 | 3 | 26.1 | 39.3 |
| 8 | 150 | 3 | 1 | 39.4 | 33.7 |
| 9 | 150 | 3 | 0.5 | 44.4 | 33.8 |
| 10 | 75 | 3 | 3 | 20.3 | 42 |
| 11 | 75 | 3 | 1 | 31.4 | 41.6 |
| 12 | 75 | 3 | 0.5 | 47.8 | 30 |
| 13 | 225 | 20 | 0.5 | 99 | 25 |
| 14 | 150 | 20 | 3 | 37.1 | 31.1 |
| 15 | 150 | 20 | 0.5 | 71.4 | 27.4 |
| 16 | 75 | 20 | 3 | 31.2 | 35.3 |
| 17 | 35 | 20 | 3 | 34.3 | 39.7 |
| 18 | 300 | 2 | 0 | 137.5 | 18.9 |
| 19 | 75 | 2 | 0 | 110 | 21.1 |
| 20 | 35 | 2 | 0 | 127.8 | 19.7 |
| 21 | 300 | 3 | 0 | 344 | 13.5 |
| 22 | 75 | 3 | 0 | 224.2 | 18.5 |

Size conditions for changing the lamp capacity “C0” are shown below. First, the tests were performed for four different clearance distances “d” between the light emitting tube 10 and external electrodes 11: 0 mm, 0.5 mm, 1.0 mm, and 3.0 mm. Then, the tests were performed for four different widths “w” of external electrodes 11 and 12: 1 mm, 2 mm, 3 mm, and 20 mm. Further, the tests were performed for five different lengths “L′” of light emitting tube 10: 80 mm, 160 mm, 310 mm, 460 mm, and 610 mm. Finally, the tests were performed for five different lengths “L” of external electrodes 11 and 12 corresponding to length “L′” of light emitting tube 10: 35 mm (L′=80 mm), 75 mm (L′=160 mm), 150 mm (L′=310 mm), and 300 mm (L′=610 mm).

The main component of external electrodes 11 is A1, and the surface of the external electrodes 11 was coated with Ag to provide the surface with a reflection function. Dimensions and materials of each individual dielectric barrier discharge lamp 100 have already been explained formerly with reference to FIGS. 1A to 2B.

The obtained measurement results are explained below. First, with regard to the lamp efficiency “η”, Table 1 does not demonstrate a relationship such that lamp efficiency “η” improves as the surface area of external electrodes 11 increases as taught in Japanese Patent Application Laid-open Publication No. H5-82101, but rather demonstrate that merely increasing the width “w” of the external electrodes 11A, 11B decreases the lamp efficiency “η”. For example, in No. 10 and No. 16 of Table 1, the length “L” of the external electrodes 11 is the same (75 mm), and the width “w” of the external electrodes 11 is 3 mm in the former and 20 mm in the latter case. Thus, in No. 16 the surface area of external electrodes 11 is larger than that in No. 10. However, in No. 16, the discharge charge quantity “q0” per unit length is larger and lamp efficiency “η” is lower than those in No. 10.

FIG. 7 demonstrates that lamp efficiency “η” has no correlation with any of individual parameters themselves that determine the dimensions and arrangement of external electrodes 11, that is, the width “w” of external electrodes 11, clearance distance “d” between the external electrodes 11 and light emitting tube 10, and length “L” of external electrodes. However, it was found that lamp efficiency “η” depends on the discharge charge quantity “q0” per unit length of external electrodes 11 (the lamp capacity C0 is adjusted by changing the width “w”, gap clearance “d”, and length “L”, thereby obtaining different values). Specifically, it was found that the lamp efficiency “η” increases when the discharge charge quantity “q0” per unit length decreases.

In FIG. 7, it was observed that a linear correlation between the discharge charge quantity “q0” per unit length and lamp efficiency “η” for twenty measurement values contained in s region “A” with a comparatively small discharge charge quantity “q0” per unit length, that is, for No. 1 to 20. Accordingly, by performing linear fitting for No. 1 to No. 20, a fitting line “C1” represented by a following formula (7) was obtained.
η=0.179×q0+41.7 (7)

Similarly, in FIG. 7, there was observed a linear correlation between the discharge charge quantity “q0” per unit length and lamp efficiency “η” for five measurement values contained in a region “B” with a comparatively large discharge charge quantity “q0” per unit length, that is, for No. 18 to 22. Accordingly, by performing linear fitting for No. 18 to 22, a fitting line “C2” represented by following formula (8) was obtained.
η=0.0288×q0+23.7 (8)

Because the inclination of fitting curve “C1” (0.179) is much larger than that of fitting curve “C2” (0.0288), a boundary where the increasing ration of the lamp efficiency “η” with respect to decrease in the discharge charge quantity “q0” becomes remarkably higher exists close to an intersection region of fitting curves C1, C2. Accordingly, when an intersection point of fitting curves C1, C2 was calculated, a value of approximately 120 nC/m shown by a symbol “D” in FIG. 7 was obtained. A measurement value with the largest discharge charge quantity “q0” from among the measurement values having the discharge charge quantities “q0” less than that of the intersection point “D”, i.e., the largest measurement value at which significant increase in the lamp efficiency “r” with respect to decrease in discharge charge quantity q0 can be observed, was No. 13 (discharge charge quantity 100 nC/m). In other words, the significant increases in the lamp efficiency “η” with respect to decrease in the discharge charge quantity “q0” is assured for measurement values having the discharge charge quantity “q0” at least less than that of No. 13 (100 nC/m).

For the reasons described above, the lamp efficiency can be greatly increased by setting the lamp capacity “C0” (for example, adjusted by the width “w” and length “L” of external electrodes 11A, 11B, and by the clearance distance “d” to the light emitting tube 10) so that the discharge charge quantity “q0” per unit length of external electrodes 11 between a pair of external electrodes 11 and per one discharge is less than 100 nC/m.

Further, although the minimum value of discharge charge quantity “q0” from among measurement values No. 1 to 22 in Table 1 and FIG. 7 is approximately 20 nC/m (No. 10), this minimum value is due to experimental limitation on the maximum applied voltage. The discharge charge quantity “q0” originating in the lamp capacity “C0” decreases with the decrease in lamp capacity “C0”. On the other hand, the smaller is the discharge charge quantity “q0”, the higher is the voltage required to induce a discharge. With a higher supplied voltage, the discharge charge quantity “q0” may be less than 20 nC/m. Usually, the lower limit values of actual lamp capacity “C0” and discharge charge quantity “q0” are set by performance of lighting circuit of each light emitting device and cost limitations.

Although the discharge charge quantity “q0” per unit length is plotted against the ordinate in FIG. 7, by converting the discharge quantity into current density, a value of approximately 0.56 mA/cm² is obtained in No. 21 and a value of approximately 0.20 mA/cm² is obtained in No. 19. The current density was calculated by dividing the lamp current density by the surface area of external electrodes 11, rather than by the cross sectional area of light emitting tube 10. This is because the external electrodes 11 are disposed in the larger area of the side surface of light emitting tube 10, which differs from an arrangement where the electrodes are present in the light emitting tube at both ends in the longitudinal direction thereof.

Table 1 and FIG. 7 relate to a case where the distance “β” between the external electrodes 11A, 11B is 7 mm, but no significant difference between characteristics was observed when the distance “β” was changed within a range from 0.5 mm to 50 mm.

The dielectric barrier discharge lamp 100 of the present embodiment constitutes part of a backlight device 700 as a flat light source device for a liquid crystal display device 900 and is disposed at the side of a light incidence plane 701a of a diffuser plate 701. In FIGS. 1A, 2A, a plurality of dielectric barrier discharge lamps 100A, 100B is arranged in a direction perpendicular to the sheet of FIG. 1 so as to be parallel to each other. A diffusion sheet 702 for scattering, the light prism sheet 703 for limiting orientation of the emitted light, and a polarization sheet 704 for limiting polarization of the emitted light are disposed in a stacked configuration at the side of a light outgoing plate 701b of the diffuser plate 701. The dielectric barrier discharge lamp 100, diffuser plate 701, and optical sheets 702 to 704 are accommodated inside a casing 705. A liquid crystal display panel 800 is disposed on a front surface of the polarization sheet 704. Light emitted by the dielectric barrier discharge lamp 100 is emitted from the light outgoing plane 701b of the diffuser plate 701, passes through the optical sheets 702 to 704, and illuminates the liquid crystal display panel 800 from the back surface side thereof.

The present invention is not limited to the above-described embodiments and various changes thereof are possible. For example, a backlight device of a liquid crystal display device was explained by way of an example, but the dielectric barrier discharge lamp in accordance with the present invention can be also used in a flat light source other than the liquid crystal display. For example, it can be used for a backlight for signboards, indoor illumination source, and illumination light source for vehicles.

The dielectric barrier discharge lamp in accordance with the present invention is suitable as a backlight source for liquid crystal display devices, backlight source for signboards, indoor illumination source, and illumination light source for vehicles.

Although the present invention has been fully described in conjunction with preferred embodiments thereof with reference to the accompanying drawings, various changes and modifications are possible for those skilled in the art. Therefore, such changes and modifications should be construed as included in the present invention unless they depart from the intention and scope of the invention as defined by the appended claims.

What is claimed is:

1. A dielectric barrier discharge lamp comprising:
a bulb;
a discharge medium comprising a rare gas and filled in the bulb;
at least a pair of external electrodes disposed outside the bulb and in series along a tube axis direction of the bulb; and
a lighting circuit for applying an alternating voltage to the pair of external electrodes so as to repeatedly generate dielectric barrier discharges and convert the rare gas into plasma for light emission,
wherein a lamp capacity defined as an electrostatic capacity between the pair of external electrodes is set such that a discharge charge quantity between the pair of external electrodes per unit length of the external electrode and per one discharge is less than 100 nC/m.

2. A dielectric barrier discharge lamp according to claim 1, wherein the lamp capacity is set by regulating at least any one of a length of the external electrodes, a width of the external electrodes, and a clearance distance between the external electrodes and the bulb.

3. A dielectric barrier discharge lamp according to claim 1, wherein the external electrodes are disposed so as to be in contact with the bulb.

4. A dielectric barrier discharge lamp according to claim 1, wherein the external electrodes are disposed at a distance from an outer circumferential surface of the bulb.

5. A backlight device, comprising:
the dielectric barrier discharge lamp according to claims 1; and
a diffuser plate with a light incoming surface and light outgoing surface for transmitting from the light incoming surface to the light outgoing surface a light emitted from the dielectric barrier discharge lamp so that the light is emitted from the light outgoing surface.

6. A liquid crystal display device, comprising:
the backlight device according to claim 5; and
a liquid crystal display panel disposed opposite to the light outgoing surface of the diffuser plate.
